(19) United States
(12) Patent Application Publication
(10) Pub. No.: US 2012/0255914 A1
(43) Pub. Date: Oct. 11, 2012

(54) METHODS FOR TREATING WASTEWATER

(76) Inventors: Gregory Kaplan, The Woodlands, TX (US); Lawrence John Karas, Spring, TX (US); Norman Glen Wise, Spring, TX (US)

(21) Appl. No.: 13/082,057

(22) Filed: Apr. 7, 2011

(51) Int. Cl. C02F 1/58; C02F 1/20; C02F 1/68

(52) U.S. Cl. 210/750; 210/749

(57) ABSTRACT

A method for treating wastewater containing organic amines including adding glyoxal to the wastewater to remove the organic amines.

### FIELD OF THE INVENTION

This invention relates generally to treating wastewater, and more particularly, to treating the wastewater from refinery processing.

### BACKGROUND OF THE INVENTION

Wastewater containing organic amines and other contaminants can be generated during refinery processing of crude oil, such as from a desalter. The wastewater may be sent to a bio-pond where microorganisms break down organic contaminants for clarifying the wastewater. A high amount of organic amines can poison the microorganisms in the bio-pond and prevent a break-down of the contaminants. Typically, the wastewater is treated to remove or neutralize organic amines before entering a bio-pond. Organic amines may be mechanically stripped from refinery wastewater; however, mechanical stripping can create bottlenecks in the refinery processing, which stop or slow the refinery. The amounts of wastewater that can pass through a mechanical stripper at one time are limited and increased time is needed for stripping wastewater with higher levels of organic amines.

United States Patent Application Publication No, 2008/0056971 discloses a system and process for treating gasification emission streams that are generated during gasification operations. Acid gas scavengers contact the gasification emission streams to remove acid gas and other emissions.

What is needed is an improved method for treating refinery wastewater to remove organic amines and other contaminants and increase crude oil processing.

### BRIEF DESCRIPTION OF THE INVENTION

In one embodiment, a method for treating wastewater containing organic amines, said method includes adding glyoxal to the wastewater to remove the organic amines.

The various embodiments provide a cost-effective and improved method for treating refinery wastewater and providing increased refinery throughput by greatly diminishing organic amines and other contaminants present in the refinery wastewater, which can poison microorganisms in a bio-pond.

### DETAILED DESCRIPTION OF THE INVENTION

The singular forms “a,” “an” and “the” include plural referents unless the context clearly dictates otherwise. The endpoints of all ranges reciting the same characteristic are independently combinable and inclusive of the recited endpoint. All references are incorporated herein by reference.

The modifier “about” used in connection with a quantity is inclusive of the stated value and has the meaning dictated by the context (e.g., includes the tolerance ranges associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

In one embodiment, a method for treating wastewater containing organic amines, said method includes adding glyoxal to the wastewater to remove the organic amines.

The wastewater is any type of wastewater containing organic amines. Any amount of the organic amines in the wastewater may be reduced and the actual amount of residual organic amines will vary depending on the starting amount. In one embodiment, the wastewater is refinery wastewater and may be any type of wastewater discharged from crude oil refineries, which process crude oil or crude oil blends, such as crude oil mixed with previously-processed heavy oil or virgin crude. The refinery wastewater will often contain organic amines at high levels, which can poison microorganisms in bio-ponds. The organic amines can occur as natural contaminants in the crude oil or may be added to the crude oil as treatment additives during processing in the refinery. The organic amities can be extracted from the crude oil into water, which may be native water that is contained in the crude oil or may be water that has been added to the crude oil during processing, such as wash water that is added to the crude oil in a desalter. The water may be separated from the crude oil or crude oil blend and may be discharged as wastewater.

In one embodiment, the organic amines may be any type of organic amine that may be used as a treatment additive or that may occur as natural contaminant. In one embodiment, the organic amines are primary amines. In another embodiment, the organic amines may include, hut are not limited to ethylene diamine EDA), methoxypropylamine (MOPA) or monoethanolamine (MEA).

In one embodiment, the organic amines are removed or scavenged by the addition of glyoxal. Glyoxal may be dispersed in the wastewater in any conventional manner. In one embodiment, the glyoxal may be delivered in metered amounts into the wastewater. In another embodiment, a feeding system may be used to add the glyoxal to the wastewater. The feeding system may include a pump and a storage container. In another embodiment, the glyoxal may be injected into the wastewater by a conventional in-line injection system and may be injected at any point in-line suitable to allow the glyoxal to mix with the wastewater. The glyoxal may be added to the wastewater in a continuous manner or can be added in one or more batch modes and repeated additions may be made.

Glyoxal is a water-soluble aldehyde and may include oligomers of the glyoxal. Glyoxal may be added in an aqueous solution. Glyoxal is commercially available as a 40 weight percent aqueous solution.

Glyoxal may be added to the wastewater in any amount sufficient to reduce the levels of organic amines in the wastewater. In one embodiment, the weight ratio of the glyoxal to the organic amines in the wastewater may be from about 0.1:1 to about 1.5:1. In another embodiment, the weight ratio of the glyoxal to the organic amines in the wastewater may be from about 0.1:1 to about 1:1. In another embodiment, the weight ratio of the glyoxal to the organic amities is from about 0.4:1 to about 0.8:1. The glyoxal may be added at ambient temperatures or elevated temperatures, as long as the wastewater remains a liquid.

In addition to organic amities, the wastewater may contain other contaminants that are generated during the refinery processing of crude oil. Contaminants that may be present in the wastewater include, but are not limited to, ammonia and hydrogen sulfide. The addition of glyoxal can also help to reduce other contaminants that may be present in the wastewater. In one embodiment, the wastewater contains organic amines and hydrogen sulfide. In another embodiment, the wastewater contains organic amines and ammonia. In another embodiment, the wastewater contains organic amines, ammonia and hydrogen sulfide.

In one embodiment, the organic amines and other contaminants are removed or scavenged by the addition of glyoxal. Any amount of contaminant may be removed or reduced and the actual amount of residual contaminants will vary depending on the starting amount. Glyoxal may be added to the wastewater in any amount sufficient to reduce the levels of organic amines and other contaminants in the wastewater. In one embodiment, glyoxal is added in an amount of from about 10 ppm by weight to about 10,000 ppm by weight, based on the weight of the wastewater. In another embodiment, glyoxal is added in an amount of from about 50 ppm by weight to about 5000 ppm by weight, based on the weight of the wastewater. In another embodiment, glyoxal is added in an amount of from about 100 ppm by weight to about 1000 ppm by weight, based on the weight of the wastewater.

In one embodiment, the wastewater may be additionally treated with a mechanical stripping process, such as a sour water stripper. The stripping process includes a stripping gas, which contacts the wastewater and helps to remove organic amines and other condensable gases or vapors. The stripping process may be any type of apparatus or method that allows a stripping gas to contact the wastewater and carry contaminants away. In one embodiment, the stripping process may be distillation or fractionation and occur in a fractionation column, distillation column, packed column, stripping column, bubble column or other suitable column for fractionation or distillation. In another embodiment, the distillation or fractionation may include packing material.

In another embodiment, the stripping process may be a gas stripping process, such as described in U.S. Pat. No. 4,689,156, which is incorporated herein by reference. In one embodiment, the stripping process comprises spraying a stripping gas through the treated wastewater. In another embodiment, gas stripping process may occur in spray towers or spray ponds.

The stripping gas may be any type of inert gas. In another embodiment, the stripping gas may be air, steam or nitrogen. In another embodiment, the stripping gas may be a hot gas.

In one embodiment, the stripping process may be applied following the treatment of the wastewater with glyoxal. The treated wastewater will pass through the mechanical stripping process at a higher rate than untreated wastewater, which minimizes bottlenecks during refinery processing.

The glyoxal scavenges or removes the organic amines quickly upon contact with the organic amines and may be used to quickly remove remaining organic amine contaminants following treatment of the wastewater with other removal processes, such as a mechanical stripping process.

In order that those skilled in the art will be better able to practice the present disclosure, the following examples are given by way of illustration and not by way of limitation.

### EXAMPLES

### Example 1

500 ppm by weight of a 40% by weight solution of glyoxal in water was added to 200 ml of deionized water containing 500 ppm by weight of methoxypropylamine (MOPA). The mixture was stirred for 1 hour at room temperature. The amount of MOPA remaining in the water (unreacted MOPA) was 390 ppm by weight. The percent reduction of the MOPA was 22%.

### Example 2

1000 ppm by weight of a 40% by weight solution of glyoxal in water was added to 200 ml of deionized water containing 500 ppm by weight of methoxypropylamine (MOPA). The mixture was stirred for 1 hour at room temperature. The amount of MOPA remaining in the water (unreacted MOPA) was 313 ppm by weight. The percent reduction of the MOPA was 37%.

### Example 3

500 ppm by weight of a 40% by weight solution of glyoxal in water was added to 200 ml of deionized water containing 500 ppm by weight of monoethanolamine (MEA). The mixture was stirred for 1 hour at room temperature. The amount of MEA remaining in the water (unreacted MEA) was 278 ppm by weight. The percent reduction of the MEA was 45%.

### Example 4

1000 ppm by weight of a 40% by weight solution of glyoxal in water was added to 200 ml of deionized water containing 500 ppm by weight of monoethanolamine (MEA). The mixture was stirred for 1 hour at room temperature. The amount of MEA remaining in the water (unreacted MEA) was 278 ppm by weight. The percent reduction of the MBA was 73%.

While typical embodiments have been set forth for the purpose of illustration, the foregoing descriptions should not be deemed to be a limitation on the scope herein. Accordingly, various modifications, adaptations and alternatives may occur to one skilled in the art without departing from the spirit and scope herein.

1. A method for treating wastewater containing organic amines, said method comprising: adding glyoxal to the wastewater to remove the organic amines.

2. The method of claim 1, wherein the wastewater is wastewater from a refinery.

3. The method of claim 1, wherein the glyoxal is injected into the wastewater.

4. The method of claim 1, wherein the glyoxal is added in a continuous manner.

5. The method of claim 1, wherein the glyoxal is added to the wastewater, in a weight ratio of glyoxal to organic amines of about 0.1:1 to about 1.5:1.

6. The method of claim 5, wherein the glyoxal is added in a weight ratio of glyoxal to organic amines of about 0.1:1 to about 1:1.

7. The method of claim 1, wherein the glyoxal is added to the wastewater at room temperature.

8. The method of claim 1 further comprising applying a stripping process to the treated wastewater.

9. The method of claim 8, wherein the stripping process comprises spraying a stripping gas through the treated wastewater.

10. The method of claim 9, wherein the stripping process occurs in a spray tower or spray pond.

11. The method of claim 9, wherein the stripping gas is an inert gas.

12. The method of claim 11, wherein the stripping gas is selected from the group consisting of: air, steam and nitrogen.

13. The method of claim 1, wherein the organic amine is a primary amine.

14. The method of claim 13, wherein the primary amine is ethylene diamine, methoxypropylamine or monoethanolamine.

15. The method of claim 1, wherein the wastewater further comprises additional contaminants and the glyoxal removes the contaminants.

16. The method of claim 15, wherein one of the additional contaminants is hydrogen sulfide.

17. The method of claim 1, wherein the glyoxal is added to the wastewater in an amount of from about 10 ppm by weight to about 10,000 ppm by weight, based on the weight of the wastewater.

18. The method of claim 15, wherein the glyoxal is added to the wastewater in an amount of from about 10 ppm by weight to about 10,000 ppm by weight, based on the weight of the wastewater.
